(19) United States
(12) Patent Application Publication
(10) Pub. No.: US 2025/0243917 A1
(43) Pub. Date: Jul. 31, 2025

(54) SYSTEMS AND METHODS FOR MOUNTING SENSORS TO DRUM BRAKES

(71) Applicant: HYUNDAI TRANSLEAD, San Diego, CA (US)

(72) Inventors: James Sangyoung OH, Irvine, CA (US); Bobby Jung BASNET, Escondido, CA (US)

(21) Appl. No.: 19/036,635

(22) Filed: Jan. 24, 2025

Related U.S. Application Data
(60) Provisional application No. 63/625,426, filed on Jan. 26, 2024.
(60) Provisional application No. 63/669,504, filed on Jul. 10, 2024.

(51) Int. Cl. F16D 66/00; F16M 13/02; G01K 1/14

(52) U.S. Cl. CPC F16D 66/00; F16M 13/02; G01K 1/14; F16D 2066/001; F16D 2250/0084

(57) ABSTRACT

A kit for installing a thermocouple sensor on a drum brake is provided. The drum brake includes a brake table having a bed side and an opposed liner side. In one aspect, the kit includes a thermocouple sensor and a mount configured to hold the thermocouple sensor in position relative to the brake table. The thermocouple sensor is configured to be inserted through a hole in the brake table. The hole is located between a first wall and a second wall of a brake web on the bed side of the brake table. The thermocouple sensor includes a tip configured to be positioned between a first brake shoe liner and a second brake shoe liner on the opposed liner side of the brake table when the thermocouple sensor is inserted through the hole in the brake table.

### CROSS-REFERENCE TO RELATED APPLICATIONS

This application claims the benefit of U.S. Provisional Application No. 63/625,426, filed Jan. 26, 2024, and U.S. Provisional Application No. 63/669,504, filed Jul. 10, 2024, which are hereby incorporated by reference in their entirety.

### BACKGROUND

### Field

The present disclosure relates generally to systems, methods, apparatuses, devices, and kits for mounting sensors on brake systems, in particular to mounting temperature sensors on drum brakes.

### Description of the Related Art

During the operation of a trailer, thermal events such as fire may occur in the wheel area. Overheating can be caused by brake drag, excess brake wear, or low levels of lubricant (e.g., oil or grease) in a brake drum. Normal operating temperatures for tires and wheels are between 100 and 150° F. Temperatures between 200 and 300° F. may impact other vehicle components, temperatures between 500 and 550° F. may cause flammable vapors to start to form, and temperatures between 650 and 700° F. may cause burning fires that are difficult to extinguish.

In many cases, a thermal event may result in a destruction of the trailer. The thermal event may cause a vehicle accident and poses danger to the trailer driver and to occupants of other vehicles involved in the accident. Further, the thermal event may result in a large financial burden to the owner of the trailer, and the destruction of any goods being transported in the trailer. Additionally, the trailer may be burnt too badly to determine the root cause of the thermal event. There is a need for improved systems, methods, apparatuses, devices, and kits for preventing or reducing such thermal events.

### SUMMARY

Embodiments disclosed herein each have several aspects no single one of which is solely responsible for the present disclosure's desirable attributes. Without limiting the scope of the present disclosure, its more prominent features will now be briefly discussed. After considering this discussion, and particularly after reading the section entitled “Detailed Description” one will understand how the features of the embodiments described herein provide advantages over existing approaches to mounting sensors on brake systems.

In one aspect, a kit for installing a thermocouple sensor on a drum brake including a brake table having a bed side and an opposed liner side is provided. The kit may include a thermocouple sensor configured to be inserted through a hole in the brake table, and a mount configured to hold the thermocouple sensor in position relative to the brake table. The hole may be located between a first wall and a second wall of a brake web on the bed side of the brake table. The thermocouple sensor may include a tip configured to be positioned between a first brake shoe liner and a second brake shoe liner on the opposed liner side of the brake table when the thermocouple sensor is inserted through the hole in the brake table.

The mount may include a bracket configured to directly contact the bed side of the brake table without contacting the hole in the brake table. The mount may include a bracket including a first bend configured to couple to the first wall of the brake web, and a second bend configured to couple to the second wall of the brake web. The bracket may include a central arm between the first bend and the second bend, the central arm including a circular divot configured to receive a flange of the thermocouple sensor. The circular divot may include a cut-out configured to receive a sleeve of the thermocouple sensor. The bracket may include a first arm terminating in a first flange and a second arm terminating in a second flange. The kit may include a plurality of clamps configured to couple to a side surface of the brake table between the first brake shoe liner and the second brake shoe liner, each of the plurality of clamps further configured to couple to the first flange or the second flange of the bracket. The mount may include a bracket configured to pass through the hole in the brake table and directly contact the bed side and the liner side of the brake table.

The mount may include a bracket including a hollow cylindrical body configured to pass through the hole in the brake table. The bracket may terminate in a plurality of flexible prongs configured to hold the tip of the thermocouple sensor in position relative to the brake table when the thermocouple sensor is received in the hollow cylindrical body and the hollow cylindrical body is received in the hole of the brake table. A body of the thermocouple sensor may include a first groove and a second groove. The kit can further include a hairpin clip configured to engage the first groove of the thermocouple sensor as the thermocouple sensor is inserted into the hole of the brake table, and the hairpin clip may be configured to engage the second groove of the thermocouple sensor after the hollow cylindrical body is received in the hole of the brake table.

The mount can include a spacer and a locking bar each including an aperture configured to receive the thermocouple sensor. The spacer may be configured to directly contact the bed side of the brake table, and the locking bar may be configured to directly contact the liner side of the brake table.

In another aspect, a bracket for mounting a thermocouple sensor on a drum brake is provided. The bracket can include a first bend configured to couple to a first wall of a brake web of the drum brake, a second bend configured to couple to a second wall of the brake web of the drum brake, and a central arm between the first bend and the second bend. The central arm can be configured to apply a downward force to a thermocouple sensor that is inserted through a hole in a brake table of the drum brake, where the hole can be located between the first wall and the second wall of the brake web.

The central arm may include a divot configured to receive a flange of the thermocouple sensor. The central arm can include a cut-out configured to receive a sleeve of the thermocouple sensor. The bracket may include a first arm and a second arm. Each of the first arm and the second arm can be configured to couple to a clamp engaged to a side of the brake table between a first brake shoe liner and a second brake shoe liner of the drum brake. The first arm may terminate in a first flange configured to bolt to a first clamp engaged to a first side of the brake table. The second arm may terminate in a second flange configured to bolt to a second clamp engaged to a second side of the brake table opposite the first side.

In a further aspect, a method of installing a thermocouple sensor on a drum brake is provided. The drum brake can include a brake table having a bed side and an opposed liner side. The method may include inserting a thermocouple sensor through a hole in the brake table, the hole located between a first wall and a second wall of a brake web on the bed side of the brake table. The method can also include installing a bracket over a section of the thermocouple sensor and the first wall and the second wall of the brake web. The method can also include coupling the bracket to a first clamp engaged to a first side of the brake table between a first brake shoe liner and a second brake shoe liner of the drum brake. The method can also include coupling the bracket to a second clamp engaged to a second side of the brake table opposite the first side.

Inserting the thermocouple sensor through the hole may include positioning a tip of the thermocouple sensor between the first brake shoe liner and the second brake shoe liner. Installing the bracket over the first wall and the second wall may include engaging a first bend of the bracket to the first wall with a friction fit and engaging a second bend of the bracket to the second wall with a friction fit. Installing the bracket over the section of the thermocouple sensor may include receiving a sleeve of the thermocouple sensor in a cut-out on a central arm of the bracket and lowering the bracket until the bracket contacts the section of the thermocouple sensor. Coupling the bracket to the first clamp may include engaging a bolt through an aperture in the first clamp and an aperture in a first arm of the bracket. Coupling the bracket to the second clamp may include engaging a bolt through an aperture in the second clamp and an aperture in a second arm of the bracket opposite the first arm.

### BRIEF DESCRIPTION OF THE DRAWINGS

Various features, aspects, and advantages of the present disclosure will now be described in connection with various embodiments, with reference to the accompanying drawings. The illustrated embodiments, however, are merely examples and are not intended to be limiting. Like reference numbers and designations in the various drawings indicate like elements.

FIG. 1 illustrates a perspective view of a vehicle axle including a pair of drum brakes according to an embodiment of the present disclosure.

FIG. 2 illustrates a perspective view of a brake shoe of the drum brake of FIG. 1.

FIG. 3 illustrates a top view of the brake shoe of FIG. 1.

FIG. 4 illustrates an exploded perspective of the brake shoe, a sensor, and a mount according to an embodiment of the present disclosure.

FIG. 5 illustrates a perspective view of the sensor of FIG. 4.

FIG. 6 illustrates a perspective view of a bracket of the mount of FIG. 4.

FIG. 7 illustrates a perspective view of a clamp that can be implemented with the mount of FIG. 4 according to an embodiment of the present disclosure.

FIG. 8 illustrates a front section view of a sensor and a mount of FIG. 4 installed on a brake shoe.

FIG. 9 illustrates a side section view of the brake shoe with a sensor and a mount of FIGS. 4 and 8 installed on a brake shoe.

FIG. 10A illustrates a perspective view of the mount of FIGS. 4 and 8 partially installed on a brake shoe.

FIG. 10B illustrates a perspective view of the mount of FIG. 10A installed on a brake shoe.

FIG. 11 illustrates a perspective view of a sensor and a mount positioned above a brake shoe according to another embodiment of the present disclosure.

FIG. 12 illustrates a front section view of the sensor and the mount of FIG. 11 installed on a brake shoe.

FIG. 13 illustrates an exploded view of the sensor and the mount of FIG. 11.

FIG. 14A illustrates the sensor in a retracted position in the mount of FIG. 11.

FIG. 14B illustrates the sensor in an extended position in the mount of FIG. 11.

FIG. 15 an exploded view of a sensor and a mount according to a further embodiment of the present disclosure.

FIG. 16 illustrates a perspective view of the sensor and the mount of FIG. 15 positioned above a brake shoe.

FIG. 17 illustrates a perspective view of the sensor and the mount of FIG. 15 being installed on the brake shoe.

FIG. 18 illustrates a perspective view of the sensor and mount of FIG. 15 installed on the brake shoe.

FIG. 19 illustrates a front section view of the sensor and the mount of FIG. 15 installed on a brake shoe.

### DETAILED DESCRIPTION

The present disclosure relates generally to systems, methods, apparatuses, devices, and kits for mounting sensors on brake systems, and more specifically, to mounts for installing a thermocouple sensor on the brake shoe of a drum brake and methods for mounting a thermocouple sensor thereon.

Although embodiments of the present disclosure are described with reference to mounts for installing a thermocouple sensor on a drum brake of a truck or trailer, it will be understood that the mounts according to the present disclosure can be suitably implemented on many different vehicles, including but not limited to trucks, buses, cars, dirt bikes, recreational vehicles, ATVs, forklifts, and construction vehicles. It will also be understood that the embodiments according to the present disclosure need not be limited to thermocouple sensors or temperature sensors. It will be understood that many types of sensors may be suitably implemented, including but not limited to thermocouple sensors, resistance temperature detectors (RTDs), infrared sensors, thermistors, proximity sensors, ultrasonic sensors, piezoelectric sensors, and semiconductor-based temperature sensors.

It is beneficial to monitor the temperature of a brake to predict thermal events before they occur, diagnose the cause of a thermal event, and/or prevent a thermal event from occurring. Thermocouple sensors can be advantageously mounted on the brake to monitor temperatures within and around the brake shoe of the brake. The present disclosure describes various systems, apparatuses, devices, and kits for installing a thermocouple sensor on a brake shoe, and methods of installing the thermocouple sensor on the brake of the trailer or other vehicle. Advantageously, existing drum brakes can be retrofitted to include thermocouple sensors using mounts according to embodiments of the present disclosure, without removing the wheel or tire from the axle.

The mounts described herein can hold a sensor in position on a brake shoe adjacent to a brake shoe liner so that the temperature near the braking surface can be measured and/or monitored. The mount can include a bracket for mounting a thermocouple sensor within a drum brake on a brake shoe. As described herein, it should be understood that a bracket can be any structure configured to fix one part to another. The brackets can fix the position of the sensor through a hole in a brake table so that a tip of the sensor is fixed in position relative to the brake table. The tip of the sensor can be fixed in position between two brake shoe liners attached to the brake table and sense and/or monitor temperature at the braking surface (for example, where the brake shoe liners contact the brake drum).

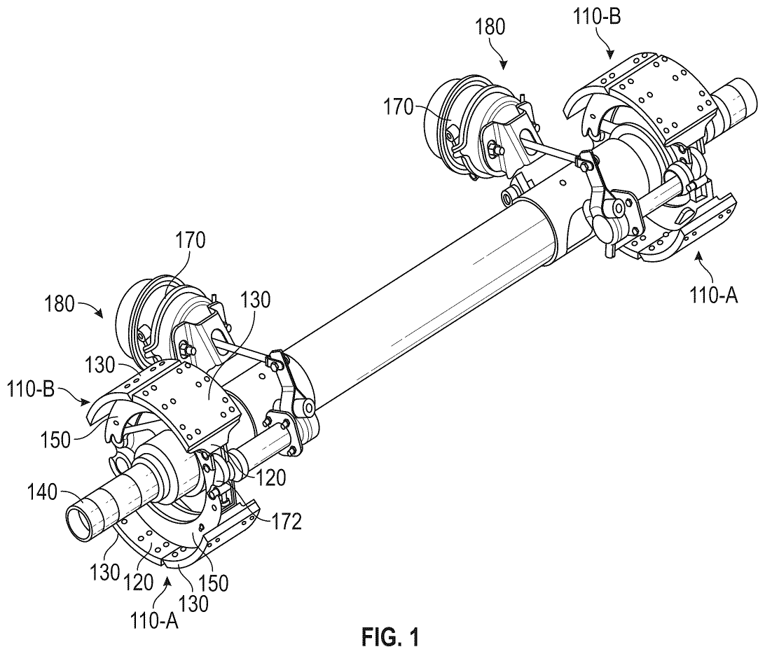

FIG. 1 illustrates a perspective view of a vehicle axle 140 including a pair of drum brakes according to an embodiment of the present disclosure. The vehicle axle 140 can be a trailer axle including pneumatic drum brakes. The wheels and brake drums are not shown for illustration purposes. Brake shoes 110 are coupled to each end of the axle 140. A first end of the axle 140 includes a first brake system 180 and a second, opposite end of the axle 140 includes a second brake system 180. The first brake system 180 can include a pneumatic cylinder 170 which can connect to an air line. The second brake system 180 can include a pneumatic cylinder 170 which can connect to the air line. In non-limiting embodiments of the present disclosure implemented on a trailer, the air line can connect to the pneumatic system on a truck when the trailer is connected to a truck.

Each brake system 180 can include a pair of brake shoes 110-A and 110-B. The brake shoe 110-A can be positioned facing towards the ground, and the brake shoe 110-B can be positioned opposite the brake shoe 110-A, facing upwards. Each brake shoe 110-A and 110-B includes a brake web 150, a brake table 120, and a pair of brake shoe liners 130 positioned concentrically around the axle 140. The brake shoe liners 130 are curved consumable surfaces, where the curved shape conforms to the inner surface of the brake drum. The brake table 120 is positioned radially inward of the brake shoe liner 130 and supports the brake shoe liner 130. The brake shoe liner 130 is coupled to the brake table 120. The brake web 150 is positioned radially inward of the brake shoe liner 130. The brake web 150 engages with a cam shaft 172 to pneumatically actuate the brake shoe 110.

Sensors can be mounted on the brake shoes 110-A and/or 110-B of a brake system, such as the brake system 180, using mounts according to embodiments of the present disclosure. In some examples, each brake system 180 on an axle 140 can include a sensor. In some examples, each axle 140 of a trailer can include one or more sensors.

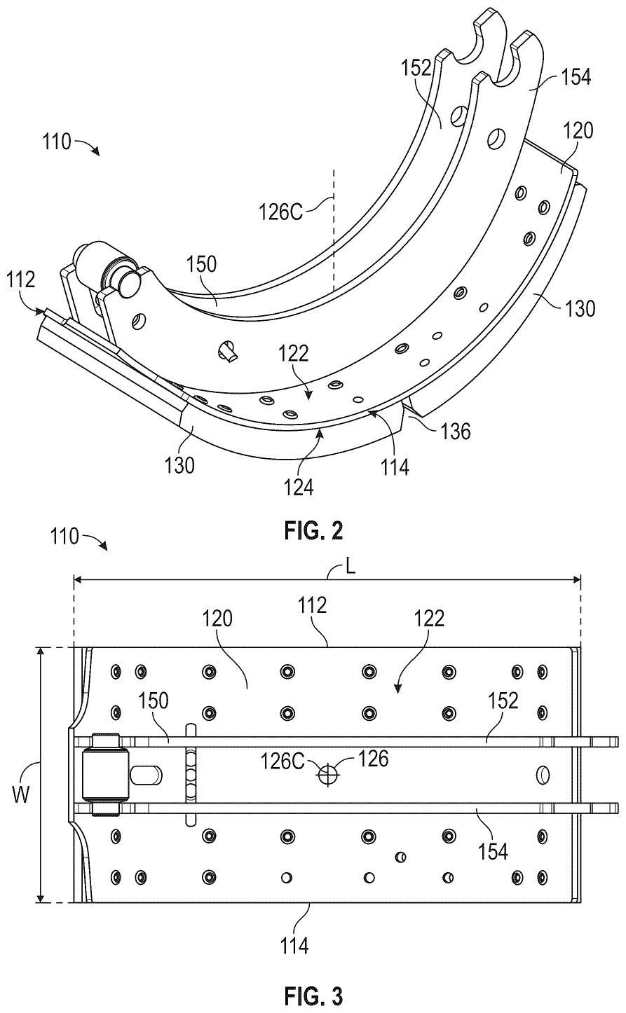

FIGS. 2 and 3 illustrate a brake shoe 110 of the drum brake of FIG. 1. The brake shoe 110 includes a brake table 120 having a length L and a width W. The brake table 120 is curved to form an arc of a circle. The brake table 120 can have a first side surface 112 at one end of the width W of the brake table 120 and a second side surface 114 at a second end of the width of the brake table 120. The first side surface 112 can be positioned on a first side of the brake shoe 110 and the second side surface 114 can be positioned on a second side of the brake shoe 110. The brake table 120 includes a bed side 122 at the radially inward concave side of the arc of the brake table 120, and a liner side 124 at the radially outward convex side of the arc of the brake table 120, opposite the bed side 122. A hole 126 (denoted by a central axis 126C in FIG. 2) extends through the brake table 120 from the bed side 122 to the liner side 124. The hole 126 includes a first opening in the bed side 122, a second opening in the opposed liner side 124, and a passageway passing through the brake table 120 between the first opening and the second opening. The hole 126 can be an industry-standard drum brake hole which is pre-existing in standard brake shoes 110. The hole 126 can be configured to allow dust, debris, dirt, moisture, and/or liquid to pass from the bed side 122 to the liner side 124. The hole 126 can allow dust and debris to exit the drum brake.

A brake web 150 is positioned on the bed side 122 of the brake table 120. The brake web 150 includes a first wall 152 and a second wall 154. The first wall 152 extends radially inward from the bed side 122 and is positioned lengthwise along the brake table 120. The first wall 152 can be substantially parallel to the first side surface 112. The first wall 152 is spaced a distance away from the first side surface 112. The second wall 154 extends radially inward from the bed side 122 and is positioned lengthwise along the brake table 120. The second wall 154 is spaced a distance away from the second side surface 114. The second wall 154 is substantially parallel to first wall 152. The first wall 152 is positioned on a first side of the hole 126 and the second wall 154 is positioned on a second, opposite side of the hole 126. The hole 126 is located between the first wall 152 and the second wall 154 of the brake web 150 on the bed side 122 of the brake table 120. The first wall 152 and the second wall 154 can be equally spaced from a centerline passing through the hole 126 and equidistant from the first side surface 112 and the second side surface 114.

A pair of brake shoe liners 130 are positioned on the liner side 124 of the brake table 120. A first brake shoe liner 130 can extend along substantially all of a first half of the length of the brake table 120 and a second brake shoe liner 130 can extend along substantially all of a second half of the length of the brake table 120. There is a gap 136 between the first brake shoe liner 130 and the second brake shoe liner 130. The gap 136 is positioned at the midpoint of the length of the brake table 120. The hole 126 is aligned with the gap 136 so that the second opening of the hole 126 is positioned between the first brake shoe liner 130 and the second brake shoe liner 130.

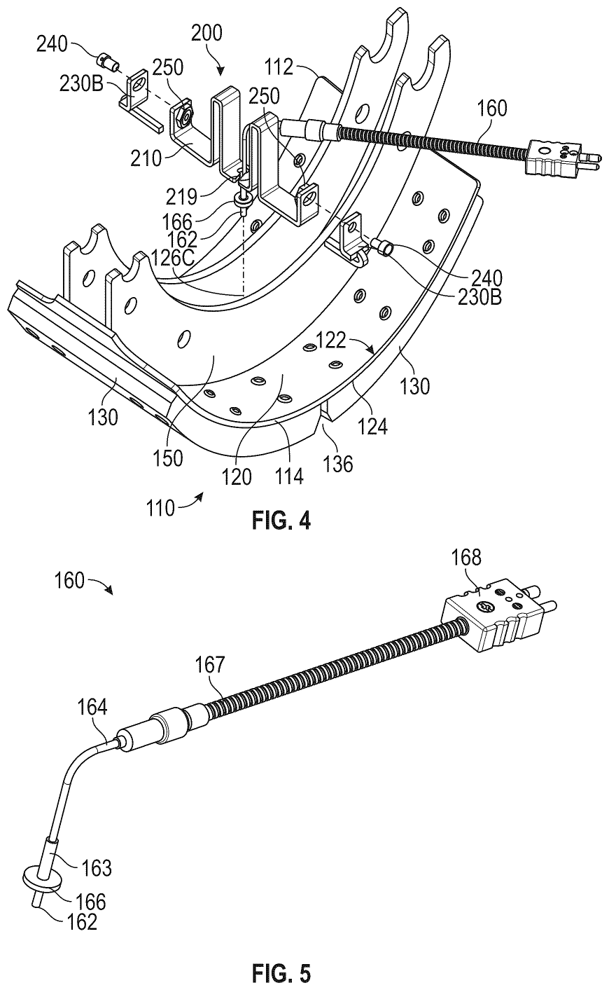

FIGS. 4-10B illustrate various features of a mount 200 configured to install a sensor 160 to a brake shoe 110 of a drum brake according to an embodiment of the present disclosure. The mount 200 is configured to attach the sensor 160, such as a thermocouple sensor, to the brake shoe 110. The mount 200 can be a component of a kit which can be installed on an existing brake shoe 110 of a drum brake. The mount 200 can be attached to any brake shoe 110 on any drum brake on any axle of a vehicle, including but not limited to a truck or a trailer. The mount 200 can engage with the brake web 150 of the brake shoe 110 to hold the sensor 160 in position relative to the brake table 120 of the drum brake. The mount 200 can be configured to hold the sensor 160 in position relative to the shoe liners 130 that are attached to the brake table 120.

FIG. 4 illustrates an exploded view of the mount 200 oriented relative to the brake shoe 110, and the sensor 160 positioned within a bracket 210 of the mount 200. The sensor mount 200 includes a bracket 210, a pair of clamps 230B, a pair of fasteners 240, and a pair of nuts 250. The mount 200 can be a component of a kit that includes a sensor 160. The bracket 210 can hold the sensor 160 in position relative to the brake shoe 110, including the brake table 120 of the brake shoe 110. The sensor 160 can slide into a cut-out 219 in the bracket 210. A sleeve 163 of the sensor 160 is positioned in the cut-out 219. A flange 166 of the sensor 160 is positioned radially inward from the bracket 210. The sensor 160 can be positioned to pass through a hole 126 in the brake table 120 of the brake shoe 110. A first clamp 230B can fasten to a first side of the bracket 210 with a fastener 240 and a nut 250. A second clamp 230B can fasten to a second side of the bracket 210 with a fastener 240 and a nut 250. The pair of clamps 230B can secure the bracket 210 to the brake shoe 110. Each of the pair of clamps 230B can be configured to couple to a side surface of the brake table 120 of the brake shoe 110, for example couple to a side surface of the brake table 120 between the first brake shoe liner 130 and the second brake shoe liner 130.

FIG. 5 illustrates a perspective view of an example sensor 160 of FIG. 4. The sensor 160 can be a temperature sensor, for example but not limited to a thermocouple sensor, a resistance temperature detector (RTD), an infrared sensor, a thermistor, or a semiconductor-based temperature sensor. The sensor 160 can be a proximity sensor, an ultrasonic sensor, or a piezoelectric sensor. The sensor 160 includes a tip 162 at a first end and a connector 168 at a second, opposite end. The connector 168 can be configured to transmit power and/or control signals to and from the tip 162. The sensor 160 can also include a sheath 164 between the tip 162 and the connector 168. The sheath 164 can be configured to protect components, such as components that transmit power and/or control signals, of the sensor 160. The sheath 164 can connect to a cable 167 coupled to the connector 168. The sensor 160 can further include a flange 166 positioned between the tip 162 and the sheath 164. The sheath 164 can include a sleeve 163 coupled to the flange 166. The sleeve 163 can be configured to protect components of the sensor from bending or flexing. In some examples, the sheath 164 can include a bend.

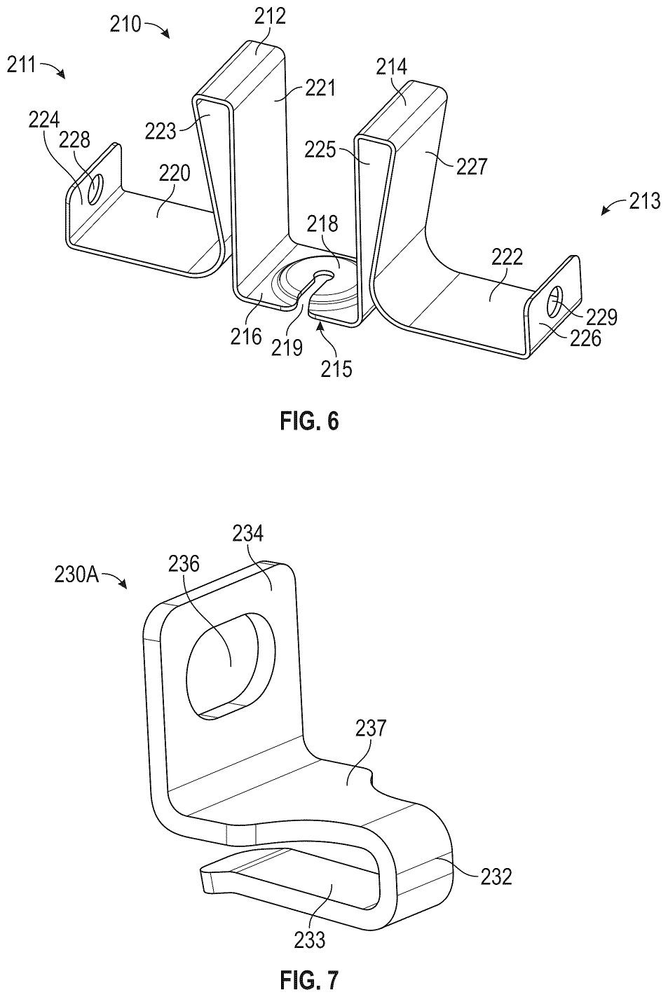

FIG. 6 illustrates a perspective view of an example bracket 210 of FIG. 4. The bracket 210 has a first side 211 and a second side 213. The bracket 210 includes a first bend 212 on the first side 211 of a central arm 216, and a second bend 214 on a second side 213 of the central arm 216. A surface 215 of the central arm 216 is configured to couple to the bed side 122 of the brake table 120. In some non-limiting examples, the surface 215 of the central arm 216 is configured to directly contact the bed side 122 of the brake table 120 when the mount 200 is installed on the brake shoe 110 The first bend 212 and the second bend 214 can be radially inward of the surface 215 of the central arm 216 when the bracket 210 is installed on the brake shoe 110. The bracket 210 can also include a first arm 220 and a second arm 222. It will be understood that the bracket 210 can be installed in a variety of orientations relative to a brake shoe 110. In one non-limiting example, the bracket 210 can be installed on a drum brake with the first side 211 proximal to the first side surface 112 of a brake shoe 110 and the second side 213 proximal to the second side surface 114. In another non-limiting example, the bracket 210 can be installed on a drum brake with the first side 211 proximal to the second side surface 114 of a brake shoe 110 and the second side 213 proximal to the first side surface 112. Prior to installation on a drum brake, the bracket 210 can be rotated or flipped freely in space.

The central arm 216 can include a divot 218. A radially inward surface of the divot 218 can have a concave shape and a radially outward surface of the divot 218 can have a convex shape. The radially outward surface of the divot 218 may not contact the bed side 122 of the brake table 120 when the mount 200 is installed on the brake shoe 110. The divot 218 can include a cut-out 219. The cut-out 219 can be a hole or slot passing through the divot 218 and extending forward through the central arm 216 between the first bend 212 and the second bend 214. The divot 218 can be circular, rectangular, oblong, or any other suitable shape.

The first bend 212 can be configured to engage a first wall 152 of a brake web 150 of the brake shoe 110, and the second bend 214 can be configured to engage a second wall 154 of the brake web 150. The first bend 212 and second bend 214 can each be U-shaped bends. The first bend 212 can have substantially the same height and width as the second bend 214. The central arm 216 is positioned between the first bend 212 and the second bend 214. The central arm 216 can be substantially perpendicular to the first bend 212 and the second bend 214.

An inward sidewall 221 (for example, the sidewall closest to the central arm 216) of the first bend 212 can form an approximate right angle with the central arm 216. An outward sidewall 223 can form an angle with a first arm 220 of the bracket 210. The angle can be a right angle, or can be smaller than a right angle, for example an 85 degree, 80 degree, 75 degree, or 70 degree angle. An inward sidewall 225 (for example, the sidewall closest to the central arm 216) of the second bend 214 can form an approximate right angle with the central arm 216. An outward sidewall 227 can form an angle with a second arm 222 of the bracket 210. The angle can be a right angle, or can be smaller than a right angle, for example an 85 degree, 80 degree, 75 degree, or 70 degree angle. The bends 212 and 214 each function as a clip. When installed on a wall, the inward sidewall 221 and the outward sidewall 223 of the first bend 212 apply a compressive force on the wall. When installed on a wall, the inward sidewall 225 and the outward sidewall 227 of the second bend 214 apply a compressive force on the wall.

The first arm 220 extends from the first bend 212 towards the first side surface 112. The first arm 220 is approximately perpendicular to the first bend 212 and approximately parallel to the central arm 216. The second arm 222 is approximately perpendicular to the second bend 214 and approximately parallel to the central arm 216. The first arm 220 terminates in a first flange 224 and the second arm 222 terminates in a second flange 226. The first flange 224 can be approximately perpendicular to the first arm 220 and the second flange 226 can be approximately perpendicular to the second arm 222. An aperture 228 can pass through the first flange 224 and an aperture 229 can pass through the second flange 226.

The bend angles of the first bend 212, second bend 214, first arm 220, and second arm 222 can advantageously cause the first bend 212 and second bend 214 to apply a spring force to a wall or structure. For example, the first bend 212 can clamp onto a wall or structure placed within the first bend 212, and the second bend 214 can clamp onto a wall or structure placed within the second bend 214. The first bend 212 can apply a compressive force to a wall or structure placed within the first bend 212, and the second bend 214 can clamp onto a wall or structure placed within the second bend 214. The wall or structure can be a wall of the brake web 150.

FIG. 7 illustrates a perspective view of an example clamp 230A that can be implemented in embodiments of the mount 200 according to embodiments of the present disclosure. The clamp 230A can include some or all of the features of the clamp 230B. It will be understood that other clamps can be suitably implemented in the embodiments of the present disclosure. The clamp 230A includes a bend 232 between a first arm 233 and a second arm 237, a flange 234, and an aperture 236. The first arm 233 and the second arm 237 can be configured to apply a spring force to a wall or structure. For example, the first arm 233 and the second arm 237 can clamp onto a wall or structure. The first arm 233 and the second arm 237 can apply a compressive force to a wall or structure. The wall or structure can be a side surface of the brake table 120 between a first brake shoe liner 130 and a second brake shoe liner 130. The clamp 230A can be installed in a variety of orientations relative to a brake shoe 110. In an example, the clamp 230A can be installed with the bend 232 proximal to the first side surface 112 of a brake shoe 110, or the bend 232 proximal to the second side surface 114. Prior to installation on a drum brake, the clamp 230A can be rotated or flipped freely in space.

The flange 234 can extend generally perpendicular to the second arm 237. The flange 234 can include an aperture 236. The first arm 233 of the bend 232 can be narrower than the flange 234. In some examples, the second arm 237 can taper from the width of the flange 234 into the narrower width of the first arm 233. In some examples, the clamp 230A can include rounded corners as the first arm 233 narrows into the bend 232. The first arm 233 can extend past the flange 234.

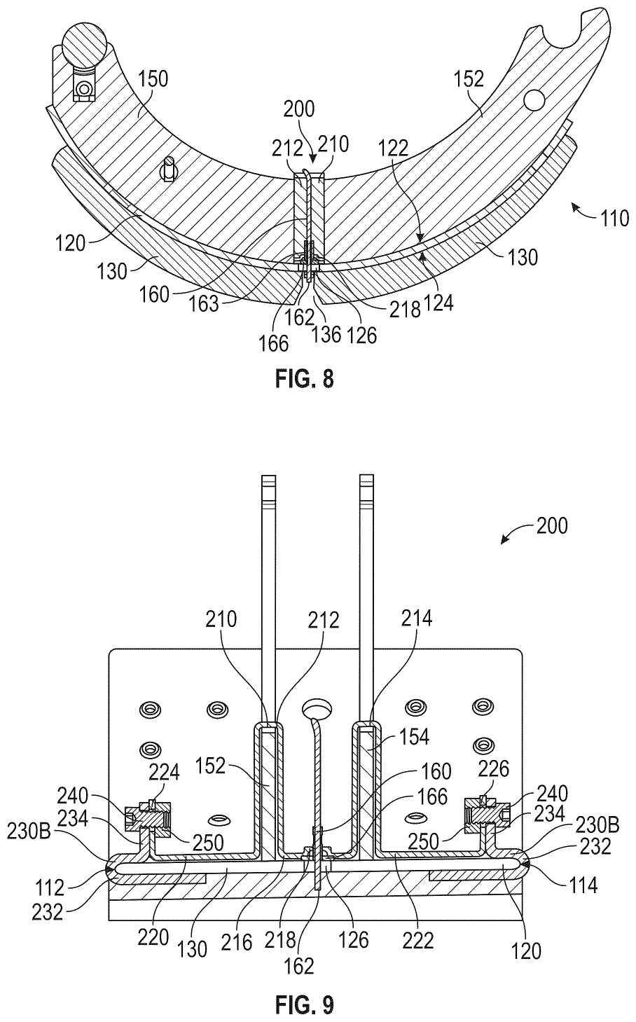

FIGS. 8-10B illustrate the mount 200 attaching a sensor 160 to a brake shoe 110 according to an embodiment of the present disclosure. The mount 200 can include a bracket 210 aligned with the gap 136 on the bed side 122 of a brake table 120, a first clamp 230B coupled to the first side surface 112 of the brake table 120, and a second clamp 230B coupled to the second side surface 114 of the brake table 120. The mount 200 can hold the sensor 160 in position relative to the brake table 120.

The bracket 210 can be coupled to the brake web 150 of the brake shoe 110. The first bend 212 and the second bend 214 of the bracket 210 are coupled to the brake web 150. The first bend 212 and the second bend 214 can extend in a radially inward direction. The first bend 212 can couple to a first wall 152 of the brake web 150. The second bend 214 can couple to a second wall 154 of the brake web 150. In some examples, the orientation of the bracket 210 can be reversed so that the first bend 212 can couple to the second wall 154 and the second bend 214 can couple to the first wall 152. The first bend 212 can engage with the first wall 152 with a friction fit. The second bend 214 can engage with the second wall 154 with a friction fit. The first bend 212 can be configured to apply a spring force to the first wall 152. The second bend 214 can be configured to apply a spring force to the second wall 154. Each of the first bend 212 and the second bend 214 can function as a spring. For example, the walls of the bend 212, 214 can press against the wall 152, 154 and generate a spring force.

The central arm 216 can be positioned over the bed side 122 of the brake table 120. In some examples, when the first bend 212 and the second bend 214 are attached to the brake web 150, the central arm 216 can be positioned radially inward of the bed side 122 of the brake table 120.

The central arm 216 includes the divot 218 having a concave surface positioned towards the bed side 122 of the brake table 120. The divot 218 can be adjacent to the hole 126 in the brake table 120. The cut-out 219 in the divot 218 can be configured to receive a portion of the sensor 160. The cut-out 219 can receive a sheath 164 of the sensor 160. A portion of the sensor 160, such as the sleeve 163 of the sheath 164, can slide through the cut-out 219. A tip 162 of the sensor 160 is positioned radially outward from the sheath 164. A portion of the sensor 160 between the tip 162 and the flange 166 extends through the hole 126 passing from the bed side 122 to the liner side 124 of the brake table 120. The tip 162 is positioned in the gap 136 and between brake shoe liners 130. The tip 162 can be positioned between the first brake shoe liner 130 and the second brake shoe liner 130 on the opposed liner side 124 of the brake table 120 when the sensor 160 is inserted through the hole 126 in the brake table 120. The flange 166 has a wider diameter than the hole 126 in the brake table 120. The flange 166 is received within the divot 218. The divot 218 can surround the flange 166. The divot 218 can apply a downward force to the flange 166 when the sensor 160 is inserted through the hole 126 in the brake table 120 and the bracket 210 is installed on the brake web 150. The sleeve 163 of the sheath 164 can be received in the cut-out 219 and the bracket 210 can be lowered until the bracket 210 contacts the flange 166 of the sensor 160 to install the bracket 210 over a section of the sensor 160. The surface 215 of the central arm 216 can directly contact the bed side 122 of the brake table 120 while the divot 218 is spaced radially inward from the brake table 120 such that the bracket 210 does not contact the hole 126. The first arm 220 and the second arm 222 can each be spaced radially inward from the central arm 216 so that when central arm 216 contacts the bed side 122, the first arm and the second arm are spaced radially inward from the bed side 122. The radially inward arrangement of the first arm 220 and the second arm 222 relative to the central arm 216 can advantageously generate a force on the flange 166 to hold the sensor 160 in place. The bracket 210 can contact the bed side 122 without contacting the hole 126 in the brake table 120. The divot 218 can contact the flange 166 to hold the sensor 160 in position relative to the cut-out 219 and the hole 126. In some non-limiting examples of the present disclosure, the surface 215 of the central arm 216 is spaced apart from the bed side 122 and does not directly contact the bed side 122 of the brake table 120.

A plurality of clamps 230B can couple the bracket 210 to the brake shoe 110. The clamps 230B can include any or all of the features of the clamp 230A described herein. A clamp 230B can engage a side of the brake table 120 between the first brake shoe liner 130 and the second brake shoe liner 130. A first clamp 230B can be positioned at the first side on the same side as the first side surface 112 of the brake table 120, and a second clamp 230B can be positioned at the second side on the same side as the second side surface 114 of the brake table 120. The first clamp 230B can clamp the first side surface 112 and couple the bracket 210 to the brake table 120, and the second clamp 230B can clamp the second side surface 114 and couple the bracket 210 to the brake table 120. The first clamp 230B can clamp the first side surface 112 in the gap 136 between the first brake shoe liner 130 and the second brake shoe liner 130. The second clamp 230B can clamp the second side surface 114 in the gap 136 between the first brake shoe liner 130 and the second brake shoe liner 130. The first clamp 230B can attach the first flange 224 of the bracket 210 to the first side surface 112 of the brake table 120. The second clamp 230B can attach the second flange 226 of the bracket 210 to the second side surface 114 of the brake table 120. A first side surface 112 can connect the bed side 122 to the liner side 124 on the first side surface 112, and a second side surface 114 can connect the bed side 122 to the liner side 124 on the second side surface 114. The first clamp 230B can directly contact the bed side 122 and the liner side 124, and the second clamp 230B can directly contact the bed side 122 and the liner side 124. In some examples, the first clamp 230B can directly contact the first side surface 112 and the second clamp 230B can directly contact the second side surface 114. The first clamp 230B can apply compressive forces to the bed side 122, the liner side 124, and/or the first side surface 112. The second clamp 230B can apply compressive forces to the bed side 122, the liner side 124, and/or the second side surface 114.

The bracket 210 can be coupled to the first clamp 230B by engaging a fastener 240 through the aperture 236 in the first clamp 230B and the aperture 228 in the first arm 220. The bracket 210 can be coupled to the second clamp 230B by engaging a fastener 240 through the aperture 236 in the second clamp 230B and the aperture 229 in the second arm 222. A fastener 240 can pass through the first clamp 230B and the first arm 220 to engage to a nut 250. A fastener 240 can pass through the second clamp 230B and the second arm 222 to fasten to a nut 250. The fastener 240 can pass through an aperture 236 in the first clamp 230B and an aperture 228 in a first flange 224 of the bracket 210. The fastener 240 can pass through an aperture 236 in the second clamp 230B and an aperture 229 in a second flange 226 of the bracket 210. The fasteners 240 can be bolts, rivets, snap-fit interfaces, or other forms of fasteners known in the art. The snap-fit interfaces can be integral to the clamps 230B. In some examples, the nuts 250 are integral to bracket 210. The nuts 250 can be welded to the first arm 220 and the second arm 222. The fasteners 240 can fasten to internal threads in the first arm 220 and second arm 222. The fasteners 240 can rivet to apertures 228 and 229. The fasteners 240 can snap-fit into the apertures 228 and 229.

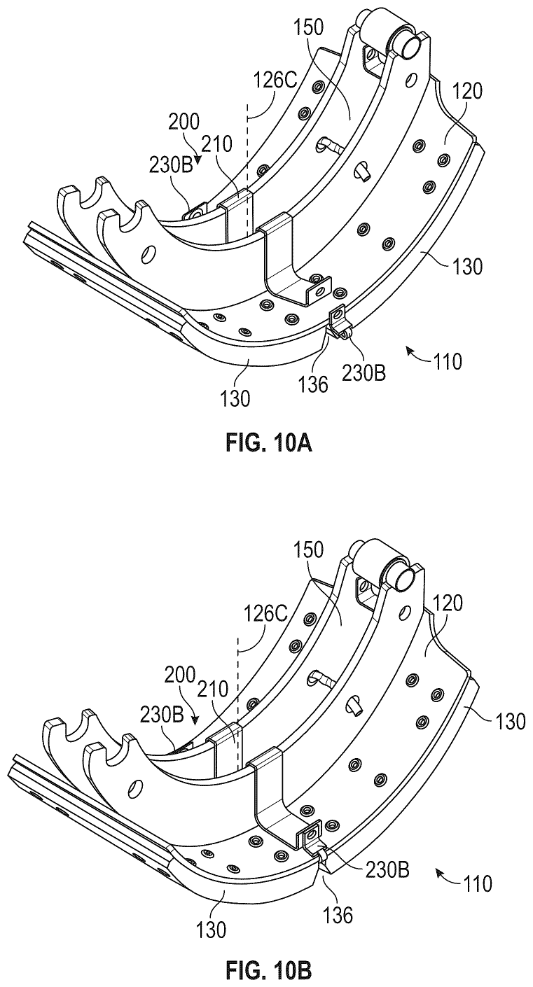

As illustrated in FIGS. 10A and 10B, the first clamp 230B and the second clamp 230B can couple the bracket 210 to the brake web 150. In some embodiments, the first flange 224 and first arm 220 can be configured to generate a spring force between the first clamp 230B and the brake table 120. The second flange 226 and the second arm 222 can be configured to generate a spring force between the second clamp 230B and the brake table 120. Clamping the first flange 224 to the first clamp 230B engaging the first side surface 112 and the second flange 226 to the second clamp 230B engaging the second side surface 114 can flex the bracket 210. Flexing the bracket 210 can generate a spring force between the first bend 212 and the first wall 152 of the brake web 150, a spring force between the second bend 214 and the second wall 154 of the brake web 150, and/or a downward force through the divot 218. The first arm 220 and second arm 222 can flex and rotate into contact with the bed side 122 of the brake table when bolted to the clamps 230. The bracket 210 is held in position under tension once bolted to the clamps 230, which can further increase the force the bracket 210 applies to the brake web 150. The force between the bracket 210 and the brake web 150 and the securement of the clamps 230 around the sides of the brake table 120 can advantageously secure the mount 200 in place.

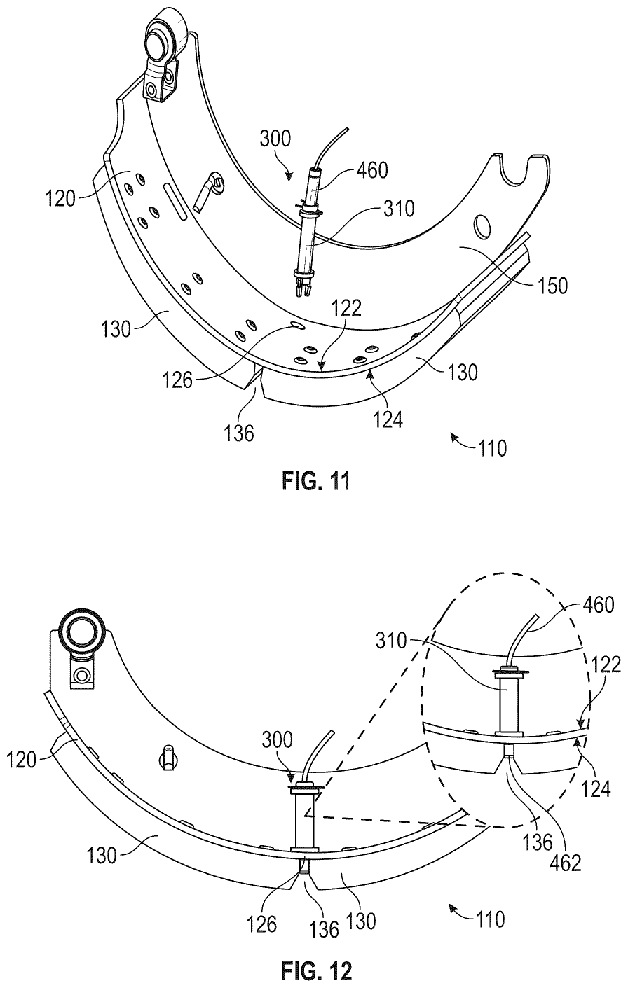

FIGS. 11-14B illustrate various features of a mount 300 for attaching a sensor 460 to a brake shoe 110 according to another embodiment of the present disclosure. The mount 300 can be a component of a kit which can be installed on an existing brake shoe 110 of a drum brake. The mount 300 can be attached to any brake shoe 110 on any drum brake on any axle of a vehicle, including but not limited to a truck or a trailer. The mount 300 can engage with the hole 126 in the brake table 120 of a brake shoe 110 to hold the sensor 460 in position relative to the brake table 120 of the drum brake. The mount 300 can be configured to hold the sensor 460 in position relative to the shoe liners 130 attached to the brake table 120 when the sensor 460 is received in the mount 300 and the mount 300 is received in the hole 126 of the brake table. The mount 300 can be snapped directly into the hole 126.

FIGS. 11 and 12 illustrate the mount 300 attaching the sensor 460 to the brake shoe 110. The mount 300 includes a bracket 310 which is configured to pass through the hole 126 in the brake shoe 110. The bracket 310 can directly contact the bed side 122 and the liner side 124 of the brake shoe 110.

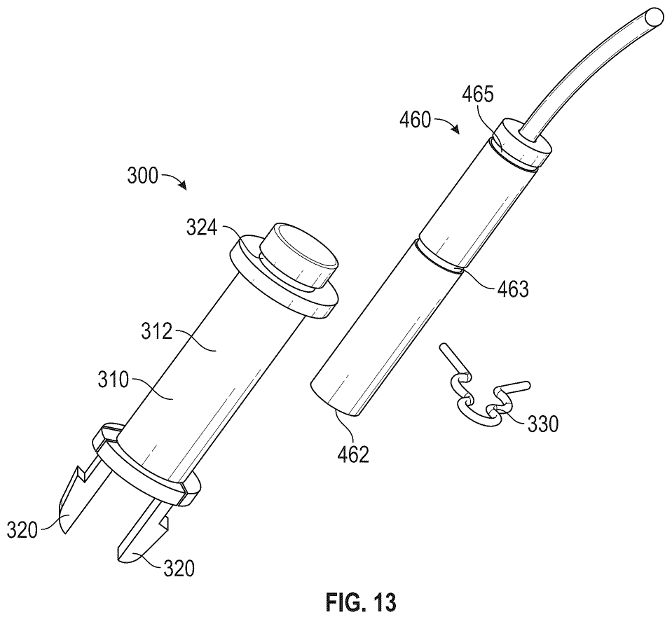

FIG. 13 illustrates an exploded view of the mount 300 and the sensor 460. The mount 300 includes a bracket 310 and a hairpin clip 330. The bracket 310 can include a hollow cylindrical body 312 configured to pass through the hole 126 in the brake table 120.

The cylindrical body 312 can terminate in a plurality of prongs 320. The cylindrical body 312 can include a hairpin clip groove 324 at an end opposite the plurality of prongs 320. The plurality of prongs 320 can be flexible. For example, the plurality of prongs 320 can be configured to flex as the cylindrical body 312 is passed through the hole 126. The plurality of prongs 320 can include a snap fit interface configured to engage the hole 126 of the brake table 120. The plurality of prongs 320 can be removably (for example, reversibly) coupled to the brake table 120 through the hole 126. The plurality of prongs 320 can be configured to hold the tip 462 of the sensor 460 in position relative to the brake table 120 when the sensor 460 is received in the cylindrical body 312 and the cylindrical body 312 is received in the hole 126 of the brake table 120. Advantageously, embodiments of the mount 300 and/or the sensor 460 according to present disclosure can be replaced. In one non-limiting example, the mount 300 and/or the sensor 460 can be replaced by bringing the plurality of prongs 320 together and pulling up on the cylindrical body 312 to extract the cylindrical body 312 from the hole 126. A new sensor 460 can be installed in the existing mount 300 and re-installed in the hole 126, or a new mount 300 (with the same sensor 460 or a new sensor 460) can be installed in the hole 126.

The sensor 460 can include a tip 462 configured to be positioned between a first brake shoe liner 130 and a second brake shoe liner 130 on the liner side 124 of the brake table 120 when the sensor 460 is inserted through the hole 126 in the brake table 120. The exterior of the sensor body can also include a first circumferential groove 463 and a second circumferential groove 465. When the sensor 460 is received in the hollow cylindrical body 312, the hairpin clip 330 can engage the grooves 463, 465 to couple the sensor body to the bracket 310 at different positions. The hairpin clip groove 324 can include apertures (for example, two apertures) through which the hairpin clip 330 can pass. The hairpin clip 330 can directly engage the sensor grooves 463, 465 through the apertures. Other types of clips can be suitably implemented.

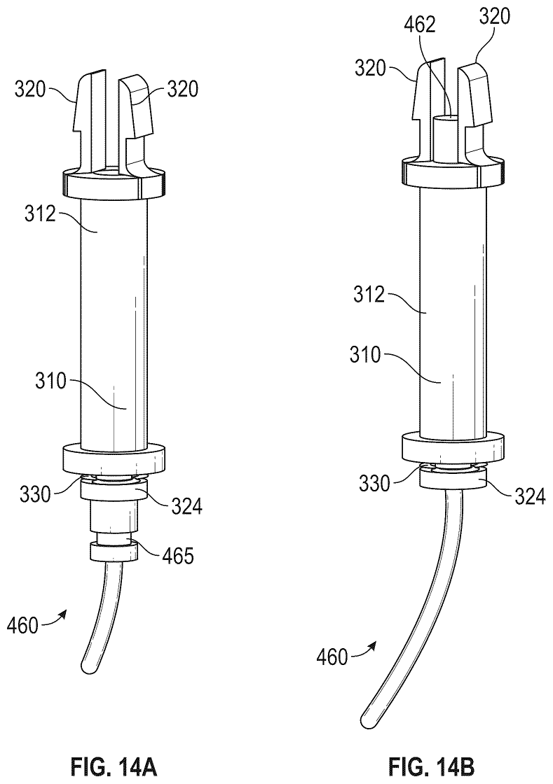

FIG. 14A illustrates the hairpin clip 330 engaged with the first groove 463. When the sensor 460 is positioned so that the hairpin clip 330 can engage with the first groove 463 through the hairpin clip groove 324 of the bracket 310, the sensor 460 is positioned in a retracted position within the bracket 310. FIG. 14B illustrates the hairpin clip 330 engaged with the second groove 464. When the sensor 460 is positioned so that the hairpin clip 330 can engage with the second groove 465 through the hairpin clip groove 324 of the bracket 310, the sensor 460 is positioned in an extended position within the bracket 310.

In some examples, the sensor 460 can be inserted into the hole 126 of the brake table 120 with the sensor 460 in a retracted position in the bracket 310. In the retracted position, the hairpin clip 330 is engaged in the first groove 463 of the sensor 460. The bracket 310 can engage with the brake table 120 with the plurality of prongs 320 positioned in the hole 126 of the brake table 120. When the first groove 463 is engaged by the hairpin clip 330 and the bracket 310 is passed through the hole 126 of the brake table 120, for example during an installation procedure, the bracket 310 is configured to maintain the position of the sensor 460 relative to the brake table 120, such that the tip 462 of the sensor 460 is not exposed to damage by the brake table 120. Thus, in embodiments of the present disclosure implementing the mount 300, the tip 462 of the sensor 460 can be advantageously protected within the cylindrical body 312 during the process of installing the bracket 310 in the hole 126 of the brake table 120, reducing or eliminating risk of damage to the sensor 460.

After the bracket 310 is engaged with the brake table 120, the hairpin clip 330 can be removed and the sensor 460 can be moved to an extended position. For example, after the cylindrical body 312 of the bracket 310 is received in the hole 126 of the brake table 120, the hairpin clip 330 can be configured to engage the second groove 465. The hairpin clip 330 can engage the second groove 465 of the sensor 460 to hold the tip 462 in the extended position relative to the brake table 120. When the second groove 465 is engaged, the bracket 310 is configured to maintain the position of the sensor 460 relative to the brake table 120, such that the tip 462 of the sensor 460 is maintained in position below the brake table 120 in the gap 136 between the brake shoe liners 130, for example during use of the sensor 460 to detect temperatures between the brake shoe liners 130.

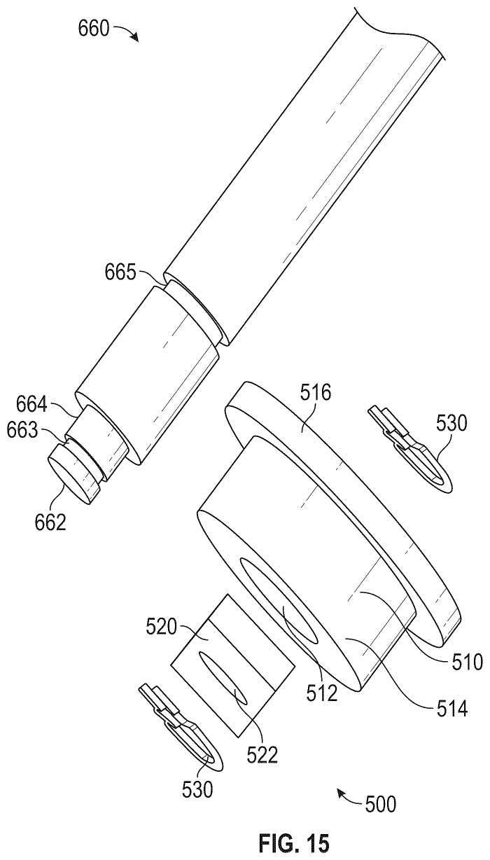

FIGS. 15-19 illustrate various features of a mount 500 for attaching a sensor 660 to a brake shoe 110 according to still another embodiment of the present disclosure. The mount 500 can be a component of a kit which can be installed on an existing brake shoe 110 of a drum brake. The mount 500 can be attached to any brake shoe 110 on any drum brake on any axle of a vehicle, including but not limited to a truck or a trailer. The mount 500 can engage with the hole 126 in the brake table 120 of a brake shoe 110 to hold the sensor 660 in position relative to the brake table 120 of the drum brake. The mount 500 can be configured to hold the sensor 660 in position relative to the shoe liners 130. The mount 500 can be attached to the brake table 120 when the sensor 660 is received in the mount 500. The mount 500 can be received in the hole 126 of the brake table 120.

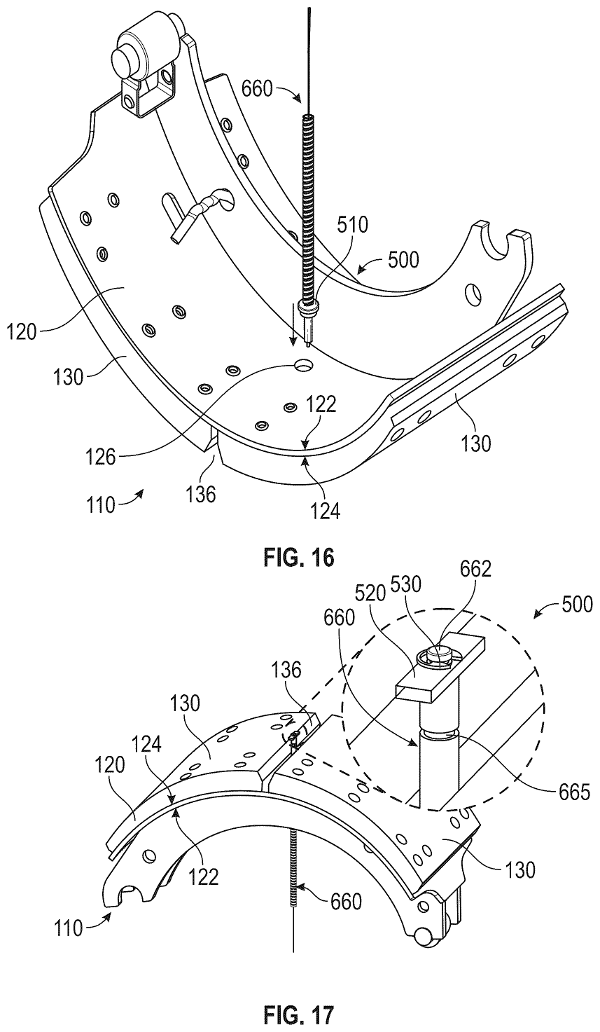

FIG. 15 illustrates an exploded view of the mount 500 and the sensor 660. FIG. 16 illustrates the mount 500 installed on the brake shoe 110 to hold the sensor 660 in position relative to the brake table 120. The mount 500 includes a spacer 510 and a locking bar 520. The spacer 510 includes an aperture 512 configured to receive the sensor 660. The locking bar 520 includes an aperture 522 configured to receive the sensor 660. The spacer 510 is configured to directly contact the bed side 122 of the brake table 120 and the locking bar 520 is configured to directly contact the liner side 124 of the brake table 120 when the mount 500 is installed through the hole 126 in the brake table 120.

The sensor 660 can include a tip 662 configured to be positioned between a first brake shoe liner 130 and a second brake shoe liner 130 on the liner side 124 of the brake table 120 when the sensor 660 is inserted through the hole 126 in the brake table 120. The exterior of the sensor body can also include a first cylindrical groove 663, an abutment face 664, and a second cylindrical groove 665.

The spacer 510 can include a flange 516 and a body 514. The body 514 can be configured to be positioned with the hole 126 of the brake table 120 while the flange 516 is configured to be in direct contact with the bed side 122 of the brake table 120. In some embodiments, the spacer 510 may be a ring, a cone, an O-ring, or a flange-less body.

The locking bar 520 can be shaped to fit within the gap 136 between the brake shoe liners 130. The locking bar 520 can be a rectangular bar. Other locking bars 520 can be suitably implemented in embodiments of the present disclosure. For example, the mount 500 can include a spacer, a ring, or an o-ring that fits within the gap 136 between the brake shoe liners 130. The locking bar 520 can be configured to abut the abutment face 664 of the sensor 660. When the mount 500 is installed through the hole 126 of the brake table 120, the spacer 510 and the locking bar 520 can be configured to hold the sensor 660 in positive relative to the brake shoe liners 130. For example, the spacer 510 can prevent the sensor 660 from moving radially inward within the gap 136 between the brake shoe liners 130, and the locking bar 520 can be configured to prevent the sensor 660 from moving radially outward within the gap 136 between the brake shoe liners 130.

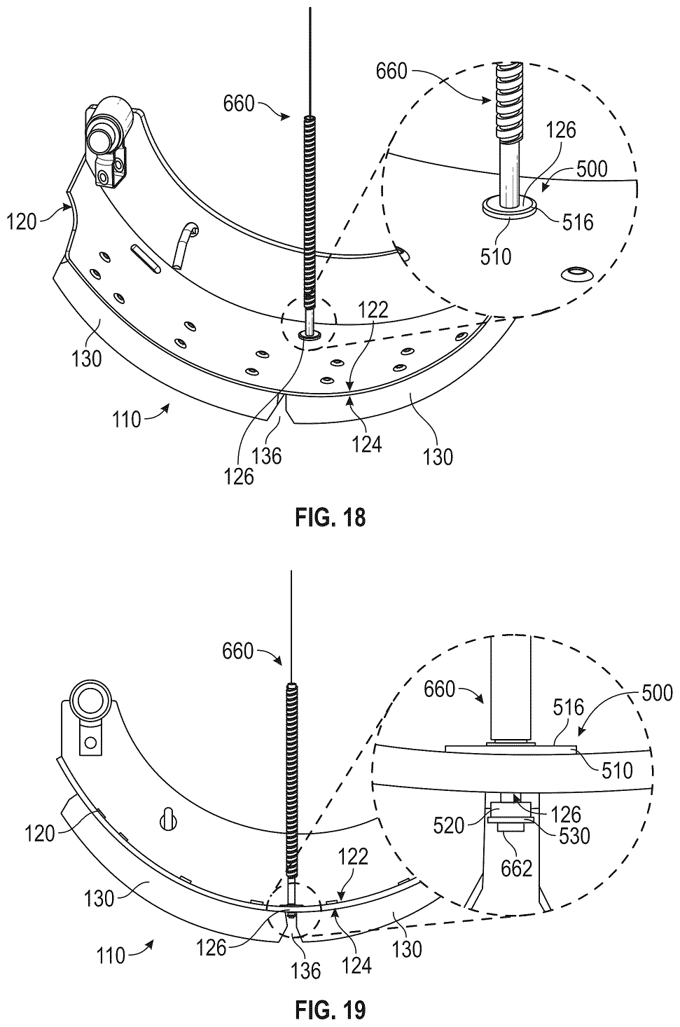

FIGS. 16-18 illustrate the sensor 660 being installed on a brake shoe 110. As illustrated in FIG. 16, the C-clips 530 and locking bar 520 are removed from the sensor 660. To install the sensor 660 on a brake shoe 110, the tip 662 of the sensor 660 is inserted into the aperture 512 of the spacer 510, with the spacer 510 oriented with the body 514 facing the tip 662. The spacer 510 is slid away from the tip 662 of the sensor 660. Next, the tip 662 of the sensor 660 is inserted through the hole 126 in the brake table 120. The tip 662 of the sensor 660 is inserted into the aperture 522 of the locking bar 520. As illustrated in FIG. 17, the locking bar 520 can be aligned to enter the gap 136 between the brake shoe liners 130 and receive the tip 662 of the sensor 660. The locking bar 520 can abut the abutment face 664. A C-clip 530 can snap into the first cylindrical groove 663 on the liner side 124 of the brake shoe liner 130 to hold the locking bar 520 in position relative to the abutment face 664. The sensor 660 is retracted from the bed side 122 to ensure that the locking bar 520 is positioned between the brake shoe liners 130. As illustrated in FIG. 18, the spacer 510 can be slid along the sensor 660 until the spacer 510 is inserted in the hole 126. The body 514 of the spacer 510 engages with the hole 126 in the brake table 120 and the flange 516 directly contacts the bed side 122 of the brake table 120. A C-clip 530 is installed into the second cylindrical groove 665 to hold the spacer 510 in position relative to the body of the sensor 660.

FIG. 19 illustrates the installed mount 500 holding the sensor 660 in position relative to the brake table 120 of a brake shoe 110 of a drum brake. The sensor 660 is inserted through the hole 126 in the brake table 120. The tip 662 of the sensor 660 is positioned between the first brake shoe liner 130 and the second brake shoe liner 130 on the liner side 124 of the brake table 120. The spacer 510 and the locking bar 520 receive the sensor 660. The spacer 510 directly contacts the bed side 122 of the brake table 120 and the locking bar 520 directly contacts the liner side 124 of the brake table 120.

The above-described embodiments have been provided by way of example, and the present invention is not limited to these examples. Multiple variations and modifications to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present invention is not intended to be limited by the disclosed embodiments.

Any feature or combination of features described herein are included within the scope of the present disclosure provided that the features included in any such combination are not mutually inconsistent as will be apparent from the context, this description, and the knowledge of one skilled in the art. In addition, any feature or combination of features may be specifically excluded from any embodiment of the present disclosure. For purposes of summarizing the present disclosure, certain aspects, advantages, and novel features of the present disclosure are described herein. Of course, not necessarily all such aspects, advantages, or features will be present in any particular embodiment of the present disclosure.

Embodiments presented herein are by way of example and not by way of limitation. The intent of the following detailed description, although discussing exemplary embodiments, is to be construed to cover all modifications, alternatives, and equivalents of the embodiments as may fall within the spirit and scope of the disclosure.

What is claimed is:

1. A kit for installing a thermocouple sensor on a drum brake comprising a brake table having a bed side and an opposed liner side, the kit comprising:
a thermocouple sensor configured to be inserted through a hole in the brake table, the hole located between a first wall and a second wall of a brake web on the bed side of the brake table, the thermocouple sensor comprising a tip configured to be positioned between a first brake shoe liner and a second brake shoe liner on the opposed liner side of the brake table when the thermocouple sensor is inserted through the hole in the brake table; and
a mount configured to hold the thermocouple sensor in position relative to the brake table.

2. The kit of claim 1, wherein the mount comprises a bracket configured to directly contact the bed side of the brake table without contacting the hole in the brake table.

3. The kit of claim 1, wherein the mount comprises a bracket comprising a first bend configured to couple to the first wall of the brake web and a second bend configured to couple to the second wall of the brake web.

4. The kit of claim 3, wherein the bracket comprises a central arm between the first bend and the second bend, the central arm comprising a circular divot configured to receive a flange of the thermocouple sensor.

5. The kit of claim 4, wherein the circular divot comprises a cut-out configured to receive a sleeve of the thermocouple sensor.

6. The kit of claim 3, wherein the bracket comprises a first arm terminating in a first flange and a second arm terminating in a second flange.

7. The kit of claim 6, further comprising a plurality of clamps configured to couple to a side surface of the brake table between the first brake shoe liner and the second brake shoe liner, each of the plurality of clamps further configured to couple to the first flange or the second flange of the bracket.

8. The kit of claim 1, wherein the mount comprises a bracket configured to pass through the hole in the brake table and directly contact the bed side and the liner side of the brake table.

9. The kit of claim 1, wherein the mount comprises a bracket comprising a hollow cylindrical body configured to pass through the hole in the brake table, the bracket terminating in a plurality of flexible prongs configured to hold the tip of the thermocouple sensor in position relative to the brake table when the thermocouple sensor is received in the hollow cylindrical body and the hollow cylindrical body is received in the hole of the brake table.

10. The kit of claim 9, wherein a body of the thermocouple sensor comprises a first groove and a second groove, wherein the kit further comprises a hairpin clip configured to engage the first groove of the thermocouple sensor as the thermocouple sensor is inserted into the hole of the brake table, and wherein the hairpin clip is configured to engage the second groove of the thermocouple sensor after the hollow cylindrical body is received in the hole of the brake table.

11. The kit of claim 1, wherein the mount comprises a spacer and a locking bar each comprising an aperture configured to receive the thermocouple sensor, the spacer configured to directly contact the bed side of the brake table and the locking bar configured to directly contact the liner side of the brake table.

12. A bracket for mounting a thermocouple sensor on a drum brake, the bracket comprising:
a first bend configured to couple to a first wall of a brake web of the drum brake;
a second bend configured to couple to a second wall of the brake web of the drum brake; and
a central arm between the first bend and the second bend, the central arm configured to apply a downward force to a thermocouple sensor that is inserted through a hole in a brake table of the drum brake, the hole located between the first wall and the second wall of the brake web.

13. The bracket of claim 12, wherein the central arm comprises a divot configured to receive a flange of the thermocouple sensor.

14. The bracket of claim 12, wherein the central arm comprises a cut-out configured to receive a sleeve of the thermocouple sensor.

15. The bracket of claim 12, wherein the bracket further comprises a first arm and a second arm, each of the first arm and the second arm configured to couple to a clamp engaged to a side of the brake table between a first brake shoe liner and a second brake shoe liner of the drum brake.

16. The bracket of claim 15, wherein the first arm terminates in a first flange configured to bolt to a first clamp engaged to a first side of the brake table, and wherein the second arm terminates in a second flange configured to bolt to a second clamp engaged to a second side of the brake table opposite the first side.

17. A method of installing a thermocouple sensor on a drum brake comprising a brake table having a bed side and an opposed liner side, the method comprising:
insert a thermocouple sensor through a hole in the brake table, the hole located between a first wall and a second wall of a brake web on the bed side of the brake table;
install a bracket over a section of the thermocouple sensor and the first wall and the second wall of the brake web;
couple the bracket to a first clamp engaged to a first side of the brake table between a first brake shoe liner and a second brake shoe liner of the drum brake; and
couple the bracket to a second clamp engaged to a second side of the brake table opposite the first side.

18. The method of claim 17, wherein inserting the thermocouple sensor through the hole comprises positioning a tip of the thermocouple sensor between the first brake shoe liner and the second brake shoe liner.

19. The method of claim 17, wherein installing the bracket over the first wall and the second wall comprises engaging a first bend of the bracket to the first wall with a friction fit and engaging a second bend of the bracket to the second wall with a friction fit.

20. The method of claim 17, wherein installing the bracket over the section of the thermocouple sensor comprises receiving a sleeve of the thermocouple sensor in a cut-out on a central arm of the bracket and lowering the bracket until the bracket contacts the section of the thermocouple sensor.

21. The method of claim 17, wherein coupling the bracket to the first clamp comprises engaging a first bolt through an aperture in the first clamp and an aperture in a first arm of the bracket, and wherein coupling the bracket to the second clamp comprises engaging a second bolt through an aperture in the second clamp and an aperture in a second arm of the bracket opposite the first arm.
